(19) United States
(12) Patent Application Publication
(10) Pub. No.: US 2011/0320532 A1
(43) Pub. Date: Dec. 29, 2011

(54) Data operating method, system, client, and data server

(75) Inventors: Jusheng Cheng, Beijing (CN); Yuan Yuan, Beijing (CN); Hai Wen, Beijing (CN)

(73) Assignee: CHENGDU HUAWEI SYMANTEC TECHNOLOGIES CO., LTD., Chengdu (CN)

(21) Appl. No.: 13/225,268

(22) Filed: Sep. 2, 2011

Related U.S. Application Data
(63) Continuation of application No. PCT/CN2010/070700, filed on Feb. 22, 2010.

(30) Foreign Application Priority Data
Mar. 4, 2009 (CN) 200910118170.9

(51) Int. Cl. G06F 15/16

(52) U.S. Cl. 709/203

(57) ABSTRACT

A data operating method, system, client, and data server are provided. The method includes: sending a write request of a file to a data server, where the write request includes identifiers of sub-data blocks constituting the file; receiving mappings between the identifiers of the sub-data blocks and storage servers returned by the data server according to the write request; and writing the sub-data blocks to the corresponding storage servers according to the mappings. With the present invention, whether the identifiers of the sub-data blocks are saved may serve as a basis for determining whether the sub-data blocks are written, thus ensuring that no duplicate data is stored in the system and increasing the storage space of the system.

### CROSS-REFERENCE TO RELATED APPLICATIONS

This application is a continuation of International Application No. PCT/CN2010/070700, filed on Feb. 22, 2010, which claims priority to Chinese Patent Application No. 200910118170.9, filed on Mar. 4, 2009 both of which are hereby incorporated by reference in their entireties.

### FIELD OF THE INVENTION

The present invention relates to the field of database technologies, and in particular, to a data operating method, system, client, and data server.

### BACKGROUND OF THE INVENTION

With the development of data storage technologies, the distributed file system is gradually applied in the field of data storage. FIG. 1 is a schematic structural diagram of a distributed file system in the prior art. The system includes: n clients, a metadata server (MDS) and in object storage servers (OSSs). Based on the architecture of this distributed file system, and taking clients writing data as an example, the clients send write requests to the MDS; after receiving the write requests, the MDS allocates objects, that is, allocates different objects (data to be written) to different OSSs according to a certain policy and notifies the clients of the allocation result which includes the information of identifiers of the OSSs; and the clients write data to the OSSs corresponding to the information of identifiers.

During the research on the prior art, the inventor finds the following problems: When different clients write data to the OSSs through the MDS, the data written may be the same, resulting in a large amount of duplicate data in the OSSs, and the duplicate data occupies the storage space of the system and reduces the available storage space of the system.

### SUMMARY OF THE INVENTION

Embodiments of the present invention provide a data operating method, system, client, and data server, which may solve the problem that the duplicate data in the distributed file system reduces the storage space of the system.

An embodiment of the present invention provides a data operating method, including: splitting the file according to a preset length to generate at least one sub-data block;

sending a write request of a file to a data server, where the write request includes identifiers of sub-data blocks constituting the file;

receiving mappings between the identifiers of the sub-data blocks and storage servers returned by the data server according to the write request; and

writing the sub-data blocks to the corresponding storage servers according to the mappings.

An embodiment of the present invention provides another data operating method, including:

saving the mappings between the identifiers of the sub-data blocks that are not found and the allocated storage servers;
receiving a write request of a file from a client, where the write request includes identifiers of sub-data blocks constituting the file;
searching for the identifiers of the sub-data blocks, and allocating storage servers for identifiers of sub-data blocks that are not found; and
returning mappings between the identifiers of the sub-data blocks constituting the file and the storage servers to the client.

An embodiment of the present invention provides a data operating system, including a client, a data server, and one or more storage servers, where:

the client is configured to splitting the file according to a preset length to generate at least one sub-data block; performing a hash operation on the at least one sub-data block, send a write request of a file to the data server, where the write request includes identifiers of sub-data blocks constituting the file, and write the sub-data blocks to corresponding storage servers according to mappings between the identifiers of the sub-data blocks and the storage servers returned by the data server; and

the data server is configured to: aving the mappings between the identifiers of the sub-data blocks that are not found and the allocated storage servers; after receiving the write request of the file, search for the identifiers of the sub-data blocks, allocate storage servers for identifiers of sub-data blocks that are not found, and return the mappings between the identifiers of the sub-data blocks constituting the file and the storage servers to the client.

An embodiment of the present invention provides a client, including: a splitting unit, configured to, according to a preset length, split the file to generate at least one sub-data block;

a sending unit, configured to send a write request of a file to a data server, where the write request includes identifiers of sub-data blocks constituting the file;

a receiving unit, configured to receive mappings between the identifiers of the sub-data blocks and storage servers returned by the data server according to the write request; and

a writing unit, configured to write the sub-data blocks to the corresponding storage servers according to the mappings.

An embodiment of the present invention provides a data server, including:

a storing unit, configured to save the mappings between the identifiers of the sub-data blocks that are not found and the storage servers;
a receiving unit, configured to receive a write request of a file from a client, where the write request includes identifiers of sub-data blocks constituting the file;
a searching unit, configured to search for the identifiers of the sub-data blocks;
an allocating unit, configured to allocate storage servers for identifiers of sub-data blocks that are not found; and
a returning unit, configured to return the mappings between the identifiers of the sub-data blocks constituting the file and the storage servers to the client.

It can be seen from the foregoing technical solution provided in embodiments of the present invention that, in the embodiments of the present invention, a client sends a write request of a file to a data server, where the write request includes identifiers of sub-data blocks constituting the file; the data server searches for the identifiers of the sub-data blocks, allocates storage servers for identifiers of sub-data blocks that are not found, and returns the mappings between the identifiers of the sub-data blocks and the storage servers to the client; and the client writes the sub-data blocks to the corresponding storage servers according to the mappings. During the file write operation, the identifiers of sub-data blocks unrecorded are saved on the data server, and the sub-data blocks are written accordingly. Therefore, whether the identifiers of the sub-data blocks are saved may serve as a basis for determining whether the sub-data blocks are written, thus reducing the duplicate data in the system and increasing the storage space of the system.

### BRIEF DESCRIPTION OF THE DRAWINGS

To explain the technical solution of the embodiments of the present invention or the prior art more clearly, the following briefly describes the drawings required in the description of the embodiments or the prior art. Obviously, the drawings are exemplary only, and those skilled in the art may obtain other drawings according to the drawings without creative efforts.

FIG. 1 is a schematic structural diagram of a distributed file system in the prior art;

FIG. 2 is a flowchart of a first embodiment of a data operating method of the present invention;

FIG. 3 is a flowchart of a second embodiment of a data operating method of the present invention;

FIG. 4 is a flowchart of a third embodiment of a data operating method of the present invention;

FIG. 5 is a flowchart of a fourth embodiment of a data operating method of the present invention;

FIG. 6 is a block diagram of an embodiment of a data operating system of the present invention;

FIG. 7 is a block diagram of a first embodiment of a client of the present invention;

FIG. 8 is a block diagram of a second embodiment of a client of the present invention;

FIG. 9 is a block diagram of a first embodiment of a data server of the present invention; and

FIG. 10 is a block diagram of a second embodiment of a data server of the present invention.

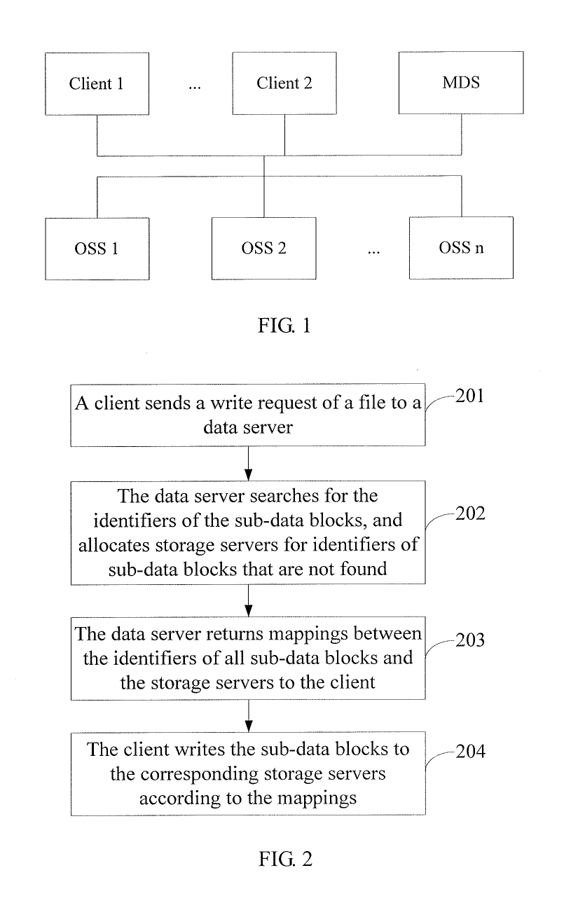

### DETAILED DESCRIPTION OF THE EMBODIMENTS

Embodiments of the present invention provide a data operating method and apparatus that are based on a distributed file system. To make the solution of the present invention better understood by those skilled in the art, and the objective, features, and advantages of the present invention more obvious and understandable, the following describes the present invention in detail with reference to accompanying drawings and embodiments.

FIG. 2 is a flowchart of the first embodiment of a data operating method based on a distributed file system. The method includes the following steps:

Step 201: A client sends a write request of a file to a data server.

The write request of the file includes identifiers of sub-data blocks constituting the file. Preferably, the identifiers of the sub-data blocks of the file include hash result values after a hash operation is performed on the sub-data block of the file.

Specifically, the file can be split according to a preset length to generate at least one sub-data block; after a hash operation is performed, the hash result value of each sub-data block is used as the identifier of the sub-data block; and the set of the identifiers of all sub-data blocks is used as the identifier of the file, and the identifier of the file is included in the sent write request of the file.

Step 202: The data server searches for the identifiers of the sub-data blocks, and allocates storage servers for identifiers of sub-data blocks that are not found.

Step 203: The data server returns mappings between the identifiers of all sub-data blocks and the storage servers to the client.

Step 204: The client writes the sub-data blocks to the corresponding storage servers according to the mappings.

To implement the embodiments of the data operating method of the present invention, it is necessary to modify the client, MDS, and OSS in the distributed file system respectively as follows:

1. Client

In addition to sending an operating request (read or write request), and reading data from the OSS or writing data to the OSS, the client splits a file into multiple sub-data blocks, performs a hash operation on the sub-data blocks, and uses the set of the calculated hash result values as the identifier of the file. For example, supposing the file is split into n sub-data blocks, which are chunk-1, chunk-2, . . . , chunk-n, a hash operation is performed on the sub-data blocks, and the hash result values (HASHKey), which are h(chunk-1), h(chunk-2), h(chunk-n), are used as the identifiers of the sub-data blocks. During the hash operation, the client may use the methods in the prior art, including SHA-1, SHA-2, SHA-256, SHA-512, one-way hash, and the like, which is not further described in the embodiments of the present invention; and accordingly, the identifier of the file is represented by the hash result values of the sub-data blocks: h(File)={h(chunk-1), h (chunk-2), h(chunk-n)}.

When splitting the file into multiple sub-data blocks, the client usually splits the file based on an equal length, that is, the sub-data blocks are equal in length, and the split length may be adjusted according to the system configuration, for example, adjusted to 1 KB, 2 KB, 4 KB, 8 KB, 16 KB, 32 KB, 64 KB, 128 KB, 256 KB, 512 KB, 1 MB, 2 MB, 4 MB, 8 MB, or 16 MB. When the end of the file is split into file data insufficient to form a sub-data block, the insufficient part is filled; and, for a small file insufficient to form a sub-data block, the client is also able to fill the insufficient part. The filling may be: null data filling, all-zero filling, or random number filling.

2. Metadata Server MDS

The MDS is modified in the file system architecture, from the current three-layer structure of Super Block→Inode Tree→Data Block to the four-layer structure of Super Block→IMAP Tree→Inode Tree→Data Block. The added IMAP Tree (sub-data block node mapping tree) is used to save the mappings between the identifiers and the nodes of sub-data blocks, and whether the sub-data blocks are saved in the OSS can be determined by querying the IMAP Tree. Because the identifiers of the sub-data blocks are expressed by the hash results of the sub-data blocks, each hash result value may uniquely represent a sub-data block. In other words, in addition to the mapping between the identifier of each sub-data block and the OSS, the MDS further saves the mapping between the identifier of each sub-data block (HASHKey) and the node of the sub-data block (Inode).

For example, there are three sub-data blocks, Block1, Block2 and Block3, with the corresponding identifiers of H(B1), H(B2) and H(B3); the corresponding nodes of the sub-data blocks are expressed by B1, B2 and B3, and the OSSs respectively for saving the sub-data blocks are OSS1, OSS2 and OSS3; in this case, the mappings (HASHKey, OSS) between the identifiers of the sub-data blocks and the OSSs saved on the MDS are as shown in Table 1.

TABLE 1

| H(B1) | H(B2) | H(B3) |
|---|---|---|
| OSS1 | OSS2 | OSS3 |

The mapping (HASHKey, Inode) between the identifier of each sub-data block (HASHKey) and the node of the sub-data block (Inode) is as shown in Table 2.

TABLE 2

| H(B1) | H(B2) | H(B3) |
|---|---|---|
| B1 | B2 | B3 |

When writing a file, the client sends the identifier of the file, h(File), to the MDS. The MDS queries the IMAP Tree according to the identifier of each sub-data block in the h(File). If the identifier of a sub-data block is already saved in the IMAP Tree, the MDS does not store the sub-data block corresponding to the identifier of the sub-data block. If the identifier of a sub-data block is not saved in the IMAP Tree, the MDS stores the mapping between the identifier and the node of the sub-data block, allocates an OSS for the sub-data block, and saves the mapping between the identifier of the sub-data block and the OSS for the subsequent query. In this way, the writing of duplicate data is avoided and the deletion of duplicate data is implemented.

3. Object Storage Server OSS

The OSS saves the corresponding sub-data block according to the identifier of the sub-data block. After querying the mapping between the identifier of the sub-data block and the OSS through the MDS, the client uses the queried identifier of the OSS as an index to store the sub-data block in the OSS or read data from the OSS.

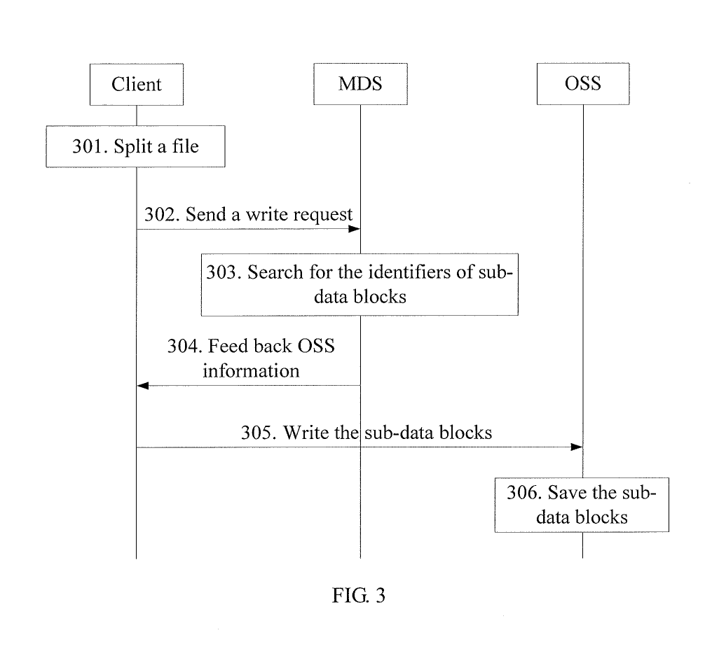

FIG. 3 is a flowchart of the second embodiment of a data operating method based on a distributed file system, illustrating how a client writes data to an OSS.

Step 301: After a local write operation, the client creates a complete file (File), and splits the file into n sub-data blocks, which are chunk-1, chunk-2, chunk-n, performs a hash operation on the sub-data blocks respectively, and obtains the identifiers of the sub-data blocks, which are h(chunk-1), h(chunk-2), h(chunk-n), thus establishing a mapping between the file and the sub-data blocks according to the identifiers of the sub-data blocks, that is, the identifier of the file, expressed by h(File)={h(chunk-1), h(chunk-2), h(chunk-n)}.

Step 302: The client sends a write request including the identifier of the file, h(File), to the MDS.

Step 303: After receiving the write request, the MDS searches for the identifiers of sub-data blocks in the established IMAP Tree according to the identifiers of the sub-data blocks included in the identifier of the file. When finding the identifier of a sub-data block, the MDS does not create new IMAP information for the identifier of the sub-data block; and when failing to find the identifier of a sub-data block, the MDS establishes a mapping between the identifier and the node of the sub-data block, that is, a new IMAP=map {h(chunk),inode}, allocates an OSS for the identifier of the sub-data block in the newly created IMAP, and saves the mapping between the identifier of the sub-data block and the OSS.

In the embodiments of the present invention, it is assumed that no identifiers of the sub-data blocks are found in the IMAP Tree.

Step 304: The MDS returns the queried OSS information to the client, that is, feeds back the mappings between the identifiers of the sub-data blocks and the OSS to the client.

Step 305: After receiving the OSS information, the client writes the sub-data blocks to the corresponding OSS according to the preceding mappings between the identifiers of the sub-data blocks and the OSS.

Step 306: After receiving the sub-data blocks, the OSS uses the identifiers of the sub-data blocks as indexes to save the sub-data blocks and may notify the client of the saving results.

In embodiments of the present invention, a file is split into multiple sub-data blocks, a hash operation is performed on the sub-data blocks, and the sub-data blocks are written according to the HASHKey. Because the hash algorithm based on content addressing and the file system architecture of the IMAP Tree are used, the problem that a lot of duplicate data exists in the distributed file system is solved, and the storage capacity is increased; and in case of frequent writing of files, the writing of duplicate data may be redirected to an existing mapping table without the subsequent process of writing data, thus improving the write performance of the distributed file system, and reducing the network load caused by the frequent writing of same data.

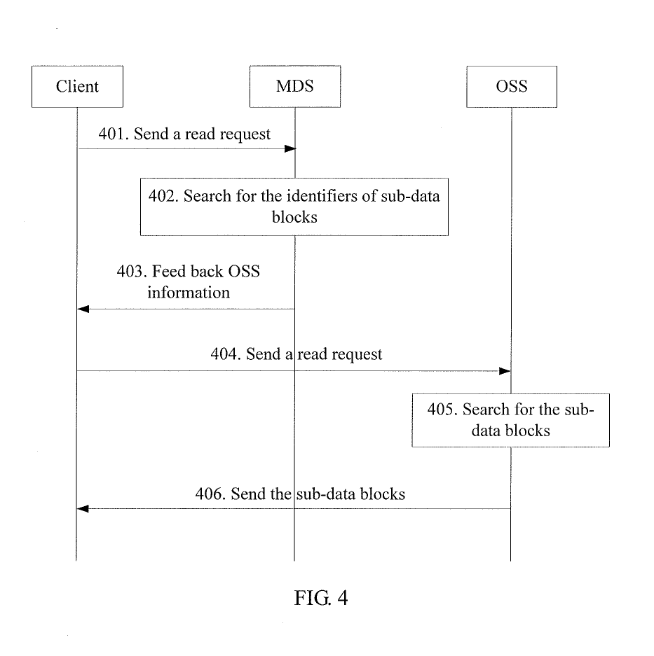

FIG. 4 is a flowchart of the third embodiment of a data operating method based on a distributed file system, illustrating how a client reads data from an OSS.

Step 401: After receiving a read request of a file, the client searches, according to the file name, for the mappings between the file and the sub-data blocks established when the file is written, and sends the read request including the found mappings h(File)={h(chunk-1), h(chunk-2), h(chunk-n)} to the MDS.

Step 402: After receiving the read request, the MDS searches for the identifiers of sub-data blocks in the established IMAP Tree according to the identifiers of the sub-data blocks included in the identifier of the file.

Step 403: The MDS returns the queried OSS information to the client, that is, feeds back the mappings between the identifiers of the sub-data blocks and the OSS to the client.

Step 404: After receiving the OSS information, the client sends the read request including the identifiers of the sub-data blocks to the corresponding OSS according to the preceding mappings between the identifiers of the sub-data blocks and the OSS.

Step 405: After receiving the read request, the OSS searches for the corresponding sub-data blocks by using the identifiers of the sub-data blocks as indexes.

Step 406: The OSS sends the found sub-data blocks to the client so that the client can read the file.

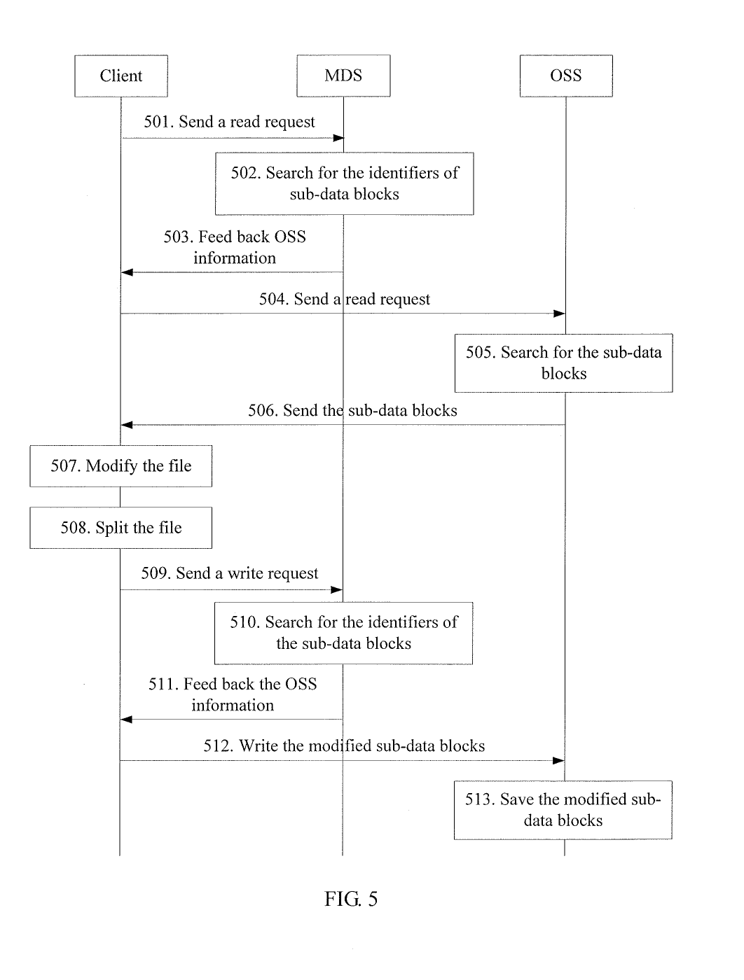

FIG. 5 is a flowchart of the fourth embodiment of a data operating method based on a distributed file system, illustrating how a client modifies data in an OSS.

Step 501: When the client needs to modify a file, the client reads the file to the local client. After receiving a modify request, the client searches, according to the file name, for the mappings between the file and the sub-data blocks established when the file is written, and sends a read request including the found mappings h(File)={h(chunk-1), h(chunk-2), h(chunk-n)} to the MDS.

Step 502: After receiving the read request, the MDS searches for the identifiers of the sub-data blocks in the established IMAP Tree according to the identifiers of the sub-data blocks included in the identifier of the file.

Step 503: The MDS returns the queried OSS information to the client, that is, feeds back the mappings between the identifiers of the sub-data blocks and the OSS to the client.

Step 504: After receiving the OSS information, the client sends the read request including the identifiers of the sub-data blocks to the corresponding OSS according to the preceding mappings between the identifiers of the sub-data blocks and the OSS.

Step 505: After receiving the read request, the OSS searches for the corresponding sub-data blocks by using the identifiers of the sub-data blocks as indexes.

Step 506: The OSS sends the found sub-data blocks to the client.

Step 507: After receiving the sub-data blocks of the whole file, the client reads the file to the local client, and modifies the contents of the file.

Step 508: The client splits the modified file into sub-data blocks. Compared with the sub-data blocks of the original file, the contents of some sub-data blocks of the modified file are changed and the contents of some sub-data blocks of the modified file are unchanged. The client performs a hash operation on all sub-data blocks to obtain the identifier of the modified file, h′(File).

Step 509: The client sends a write request including the identifier of the file, h′(File), to the MDS.

Step 510: After receiving the write request, the MDS searches for the identifiers of the sub-data blocks in the established IMAP Tree according to the identifiers of the sub-data blocks included in the identifier of the file. The sub-data blocks with the contents unchanged can be searched out according to the indexes of the sub-data blocks generated by the hash operation, and therefore the MDS does not create new IMAP information for the identifiers of the sub-data blocks. The sub-data blocks with the contents changed cannot be searched out according to the indexes of the sub-data blocks generated by the hash operation, and therefore the MDS establishes mappings between the identifiers and the nodes of those sub-data blocks, that is, a new IMAP=map {h(chunk),inode}, allocates an OSS for the identifiers of the sub-data blocks in the new IMAP, and saves the mapping between the identifiers of the sub-data blocks and the OSS.

Step 511: The MDS returns the new mappings between the identifiers of the sub-data blocks and the OSS to the client.

Step 512: After receiving the OSS information, the client writes the sub-data blocks to the corresponding OSS according to the preceding mappings between the identifiers of the sub-data blocks and the OSS.

Step 512: After receiving the sub-data blocks, the OSS uses the identifiers of the sub-data blocks as indexes to save the sub-data blocks and may notify the client of the saving results. The modification of the file is complete.

During the modification above, the OSS does not delete the original sub-data blocks corresponding to the modified sub-data blocks, but still reserves the original sub-data blocks, because the original sub-data blocks may be one part of the other files.

Corresponding to the embodiments of the data operating method of the present invention, embodiments of a data operating system, client, and data server are also provided.

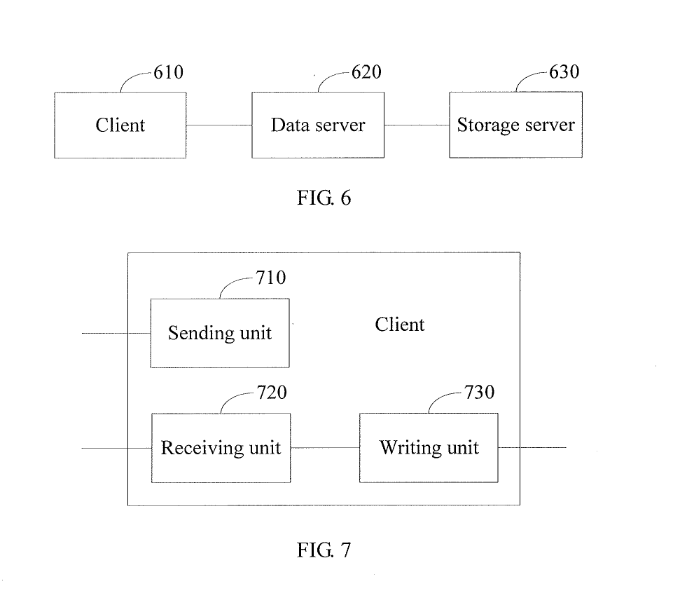

FIG. 6 is a block diagram of an embodiment of a data operating system of the present invention. The system includes: a client 610, a data server 620, and a storage server 630. There may be multiple clients and storage servers, but only one client and one storage server are illustrated in FIG. 6.

The client 610 is configured to send a write request of a file to the data server 620, where the write request includes identifiers of sub-data blocks constituting the file, and write the sub-data blocks to the corresponding storage server 630 according to the mappings between the identifiers of the sub-data blocks and the storage server 630 returned by the data server 620. The data server 620 is configured to: after receiving the write request of the file, search for the identifiers of the sub-data blocks, allocate the storage server 630 for the identifiers of sub-data blocks that are not found, and return the mappings between the identifiers of the sub-data blocks constituting the file and the storage server 630 to the client 610.

FIG. 7 is a block diagram of the first embodiment of a client of the present invention. The client includes: a sending unit 710, a receiving unit 720, and a writing unit 730.

The sending unit 710 is configured to send a write request of a file to a data server, where the write request includes identifiers of sub-data blocks constituting the file. The receiving unit 720 is configured to receive mappings between the identifiers of the sub-data blocks and storage servers returned by the data server according to the write request. The writing unit 730 is configured to write the sub-data blocks to the corresponding storage servers according to the mappings.

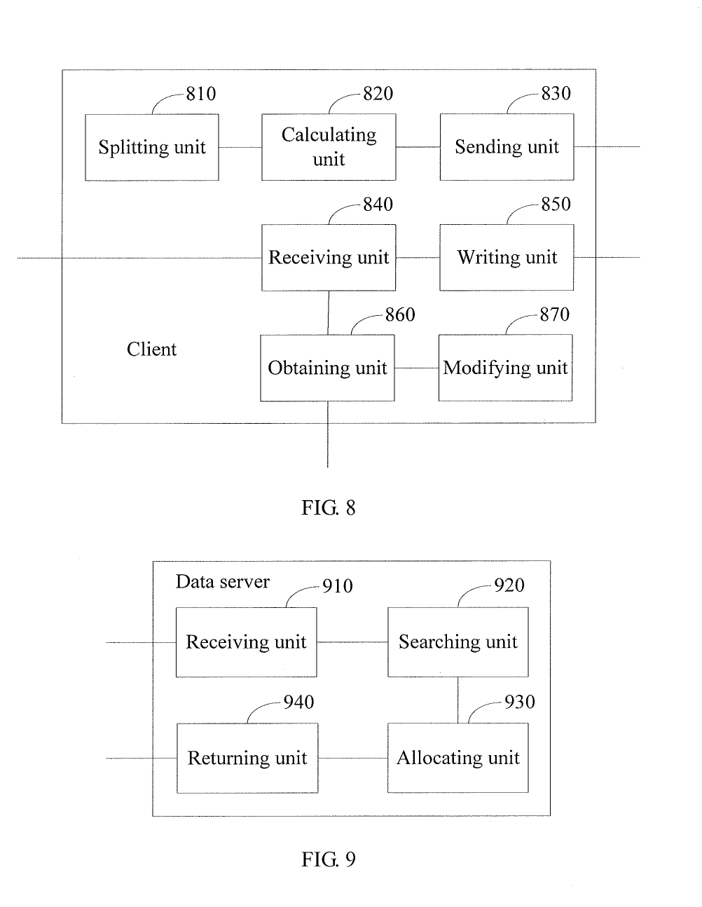

FIG. 8 is a block diagram of the second embodiment of a client of the present invention. The client includes: a splitting unit 810, a calculating unit 820, a sending unit 830, a receiving unit 840, a writing unit 850, an obtaining unit 860, and a modifying unit 870.

The splitting unit 810 is configured to, according to a preset length, split a file to be written to generate at least one sub-data block. The calculating unit 820 is configured to perform a hash operation on the at least one sub-data block, and use the hash result value of each sub-data block as the identifier of the sub-data block and the set of the identifiers of all sub-data blocks as the identifier of the file, where the identifier of the file is included in the write request of the file.

The sending unit 830 is configured to send a write request of a file to a data server, where the write request includes identifiers of sub-data blocks constituting the file. The receiving unit 840 is configured to receive mappings between the identifiers of the sub-data blocks and storage servers returned by the data server according to the write request. The writing unit 850 is configured to write the sub-data blocks to the corresponding storage servers according to the mappings.

The sending unit 830 is further configured to send a read request of a file to the data server, where the read request includes identifiers of sub-data blocks constituting the file. The receiving unit 840 is further configured to receive mappings between the identifiers of the sub-data blocks and storage servers returned by the data server according to the read request. The obtaining unit 860 is configured to obtain the corresponding sub-data blocks from the storage servers according to the mappings to finish reading the file.

The modifying unit 870 is configured to modify the file obtained by the obtaining unit 860, and afterward the sending unit 830 sends the write request of the file to the data server.

FIG. 9 is a block diagram of the first embodiment of a data server of the present invention. The data server includes: a receiving unit 910, a searching unit 920, an allocating unit 930, and a returning unit 940.

The receiving unit 910 is configured to receive a write request of a file from a client, where the write request includes identifiers of sub-data blocks constituting the file. The searching unit 920 is configured to search for the identifiers of the sub-data blocks. The allocating unit 930 is configured to allocate storage servers for identifiers of sub-data blocks that are not found. The returning unit 940 is configured to return mappings between the identifiers of the sub-data blocks constituting the file and the storage servers to the client.

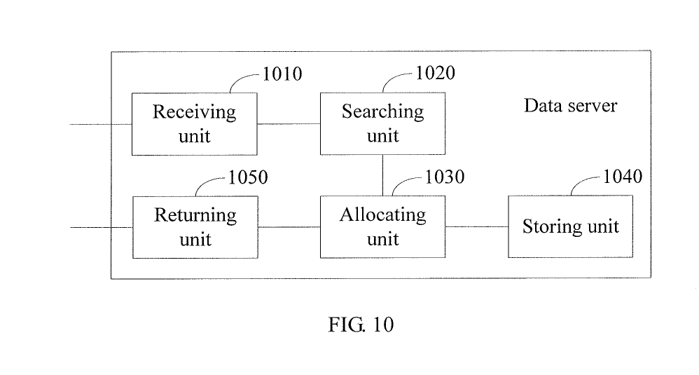

FIG. 10 is a block diagram of the second embodiment of a data server of the present invention. The data server includes: a receiving unit 1010, a searching unit 1020, an allocating unit 1030, a storing unit 1040, and a returning unit 1050.

The receiving unit 1010 is configured to receive a write request of a file from a client, where the write request includes identifiers of sub-data blocks constituting the file. The searching unit 1020 is configured to search for the identifiers of the sub-data blocks. The allocating unit 1030 is configured to allocate storage servers for identifiers of sub-data blocks that are not found. The storing unit 1040 is configured to save mappings between the identifiers of the sub-data blocks that are not found and the storage servers. The returning unit 1050 is configured to return the mappings between the identifiers of the sub-data blocks constituting the file and the storage servers to the client.

The receiving unit 1010 is further configured to receive a read request of the file from the client, where the read request includes identifiers of sub-data blocks constituting the file. The searching unit 1020 is further configured to search for the mappings according to the identifiers of the sub-data blocks. The returning unit 1050 is further configured to return the found mappings to the client.

It can be seen from the description of the embodiments of the present invention, in the embodiments of the present invention, the client sends a write request of a file to a data server, where the write request includes identifiers of sub-data blocks constituting the file; the data server searches for the identifiers of the sub-data blocks, allocates storage servers for identifiers of sub-data blocks that are not found, and returns mappings between the identifiers of the sub-data blocks constituting the file and the storage servers to the client; and the client writes the sub-data blocks to the corresponding storage servers according to the mappings. During the file write operation, the identifiers of sub-data blocks unrecorded are saved on the data server, and the sub-data blocks are written accordingly. Therefore, whether the identifiers of the sub-data blocks are saved may serve as a basis for determining whether the sub-data blocks are written, thus ensuring that no duplicate data is stored in the system and increasing the storage space of the system.

Those skilled in the art may clearly understand that the present invention may be implemented by software in addition to a necessary general hardware platform. Based on the understanding, the essence of the technical solution of the present invention or the contributions to the prior art may be reflected in the form of a software product. The computer software product may be stored in a storage medium, such as a read only memory or random access memory (ROM/RAM), a magnetic disk, and a compact disk-read only memory (CD-ROM), and includes multiple instructions to enable a computer device (a personal computer, a server, or a network device) to execute the method of each embodiment or some parts of the embodiment of the present invention.

Although the present invention is described with reference to some embodiments, those skilled in the art know that modifications and variations may be made to the present invention without departing from the spirit of the present invention. All such modifications and variations shall fall within the scope of the present invention defined by the appended claims.

What is claimed is:

1. A data operating method, comprising:
splitting the file according to a preset length to generate at least one sub-data block; sending a write request of a file to a data server, wherein the write request comprises identifiers of sub-data blocks constituting the file;
receiving mappings between the identifiers of the sub-data blocks and storage servers returned by the data server according to the write request; and
writing the sub-data blocks to the corresponding storage servers according to the mappings.

2. The method according to claim 1, further comprising:
sending a read request of the file to the data server, wherein the read request comprises the identifiers of the sub-data blocks constituting the file;
receiving the mappings between the identifiers of the sub-data blocks and the storage servers returned by the data server according to the read request; and
obtaining the corresponding sub-data blocks from the storage servers according to the mappings to finish reading the file.

3. The method according to claim 2, further comprising:
modifying the read file, and executing the step of sending the write request of the file to the data server.

4. The method according to claim 1, before sending the request to the data server, further comprising:
performing a hash operation on the at least one sub-data block, and using a hash result value of each sub-data block as the identifier of the sub-data block and a set of identifiers of all sub-data blocks as an identifier of the file, wherein the identifier of the file is comprised in the write request of the file.

5. The method according to claim 1, wherein the identifiers of the sub-data blocks of the file comprise: hash result values after a hash operation is performed on the sub-data blocks of the file.

6. A data operating method, comprising:
saving the mappings between the identifiers of the sub-data blocks that are not found and the allocated storage servers;
receiving a write request of a file from a client, wherein the write request comprises identifiers of sub-data blocks constituting the file;
searching for the identifiers of the sub-data blocks, and allocating storage servers for identifiers of sub-data blocks that are not found; and
returning mappings between the identifiers of the sub-data blocks constituting the file and the storage servers to the client.

7. The method according to claim 6, further comprising:
receiving a read request of the file from the client, wherein the read request comprises the identifiers of the sub-data blocks constituting the file;
searching for the mappings according to the identifiers of the sub-data blocks; and
returning the found mappings to the client.

8. The method according to claim 6, wherein the identifiers of the sub-data blocks of the file comprise: hash result values after a hash operation is performed on the sub-data blocks of the file.

9. A data operating system, comprising a client, a data server, and one or more storage servers, wherein:
the client is configured to splitting the file according to a preset length to generate at least one sub-data block; performing a hash operation on the at least one sub-data block, send a write request of a file to the data server, wherein the write request comprises identifiers of sub-data blocks constituting the file, and write the sub-data blocks to corresponding storage servers according to mappings between the identifiers of the sub-data blocks and the storage servers returned by the data server; and
the data server is configured to: saving the mappings between the identifiers of the sub-data blocks that are not found and the allocated storage servers; after receiving the write request of the file, search for the identifiers of the sub-data blocks, allocate storage servers for identifiers of sub-data blocks that are not found, and return the mappings between the identifiers of the sub-data blocks constituting the file and the storage servers to the client.

10. A client, comprising:
a splitting unit, configured to, according to a preset length, split the file to generate at least one sub-data block; a sending unit, configured to send a write request of a file to a data server, wherein the write request comprises identifiers of sub-data blocks constituting the file;
a receiving unit, configured to receive mappings between the identifiers of the sub-data blocks and storage servers returned by the data server according to the write request; and
a writing unit, configured to write the sub-data blocks to the corresponding storage servers according to the mappings.

11. The client according to claim 10, wherein:
the sending unit is further configured to send a read request of the file to the data server, wherein the read request comprises the identifiers of the sub-data blocks constituting the file, and
the receiving unit is further configured to receive the mappings between the identifiers of the sub-data blocks and the storage servers returned by the data server according to the read request;
the client further comprises:
an obtaining unit, configured to obtain the corresponding sub-data blocks from the storage servers according to the mappings to finish reading the file.

12. The client according to claim 11, further comprising:
a modifying unit, configured to modify the file obtained by the obtaining unit, and afterward the sending unit sends the write request of the file to the data server.

13. The client according to claim 10, further comprising:
a calculating unit, configured to perform a hash operation on the at least one sub-data block, and use a hash result value of each sub-data block as the identifier of the sub-data block and a set of identifiers of all sub-data blocks as an identifier of the file, wherein the identifier of the file is comprised in the write request of the file.

14. A data server, comprising:
a storing unit, configured to save the mappings between the identifiers of the sub-data blocks that are not found and the storage servers;
a receiving unit, configured to receive a write request of a file from a client, wherein the write request comprises identifiers of sub-data blocks constituting the file;
a searching unit, configured to search for the identifiers of the sub-data blocks;
an allocating unit, configured to allocate storage servers for identifiers of sub-data blocks that are not found; and
a returning unit, configured to return mappings between the identifiers of the sub-data blocks constituting the file and the storage servers to the client.

15. The client according to claim 14, wherein,
the receiving unit is further configured to receive a read request of the file from the client, wherein the read request comprises the identifiers of the sub-data blocks constituting the file;
the searching unit is further configured to search for the mappings according to the identifiers of the sub-data blocks; and
the returning unit is further configured to return the found mappings to the client.
